(19) United States
(12) Patent Application Publication
(10) Pub. No.: US 2020/0313541 A1
(43) Pub. Date: Oct. 1, 2020

(54) SMOOTHING CIRCUIT, INVERTER, AND POWER SUPPLY APPARATUS

(71) Applicant: NETUREN CO., LTD., Tokyo (JP)

(72) Inventors: Takahiko KANAI, Shinagawa-ku, Tokyo (JP); Haruki YOSHIDA, Shinagawa-ku, Tokyo (JP)

(73) Assignee: NETUREN CO., LTD., Tokyo (JP)

(21) Appl. No.: 16/760,965

(22) PCT Filed: Oct. 2, 2018
(86) PCT No.: PCT/JP2018/036912

§ 371 Date: May 1, 2020

(30) Foreign Application Priority Data
Nov. 1, 2017 (JP) 2017-212184

(51) Int. Cl. H02M 1/14; H02M 7/00; H02M 7/5387

(52) U.S. Cl. CPC H02M 1/14; H02M 5/293; H02M 7/5387; H02M 7/003

(57) ABSTRACT

An inverter of a power supply apparatus includes a smoothing circuit. The smoothing circuit includes a circuit body having a positive-side output terminal and a negative-side output terminal, and a plurality of capacitors mounted on the circuit body and connected in parallel between the positive-side output terminal and the negative-side output terminal. A difference between the maximum value and the minimum value among positive-negative electrical path lengths ln_{PNi}=ln_{Pi}+ln_{Ni} (i=1, 2, and 3) for the respective capacitors is equal to or smaller than 30% of the minimum value.

### TECHNICAL FIELD

The present invention relates to a smoothing circuit, an inverter, and a power supply apparatus.

### BACKGROUND ART

AC power supplied to a heating coil used for induction heating is generally generated through a process of convening AC power of a commercial power supply into DC power through a converter and inversely converting the converted DC power into AC power of a desired frequency through an inverter. The inverter includes a plurality of power semiconductor devices, and the inverse conversion from DC power to AC power is performed by switching operations of the plurality of power semiconductor devices.

In a voltage-type inverter, DC power smoothed through a capacitor is supplied to power semiconductor devices. A first related art power conversion apparatus includes a first smoothing capacitor and a second smoothing capacitor having a smaller capacitance and high-frequency impedance than the first smoothing capacitor and disposed more adjacent to a semiconductor switching element than the first smoothing capacitor (see, e.g., to JP2004-254355A). A second related art power supply apparatus includes a plurality of capacitors arranged adjacent to a power semiconductor device, and the plurality of capacitors are connected in parallel to each other (see, e.g., JP2017-004593A).

A high-speed switching operation of the power semiconductor device rapidly changes a current flowing through the power semiconductor device, and the current change di/dt generates a surge voltage (L×di/dt) across the power semiconductor device through inductance L such as inductance of an electrical path between the power semiconductor device and a capacitor serving as a voltage source or internal inductance of the capacitor. An excessive surge voltage may destroy the power semiconductor device, and thus needs to be prevented. Since the current change di/dt is mainly decided by the characteristics of the power semiconductor device, the surge voltage can be prevented by reducing the inductance L.

As a method for reducing the inductance L, as in the first related art power conversion apparatus, for example, the capacitor may be disposed adjacent to the power semiconductor device. Accordingly, the inductance of the electrical path between the power semiconductor device and the capacitor can be reduced.

As another method for reducing the inductance L, as in the second related art power supply apparatus, the plurality of capacitors may be arranged adjacent to the power semiconductor device, and connected in parallel to each other. Accordingly, equivalent inductance corresponding to combined internal inductance of the plurality of capacitors can be reduced, and smaller capacitors can be disposed close to the power semiconductor device.

In order to effectively use the plurality of capacitors connected in parallel to each other, it is necessary to suppress a variation in current flowing through each of the capacitors. That is because a capacitor through which a relatively large amount of current flows is likely to be destroyed by heat generated therefrom. Furthermore, when a variation occurs in the current flowing through each of the capacitors connected in parallel to each other, internal inductance of a capacitor through which a relatively large amount of current flows becomes dominant in the combined internal inductance of the plurality of capacitors. As a result, the equivalent inductance corresponding to the combined internal inductance of the plurality of capacitors is not sufficiently reduced, and the preventing effect for a surge voltage may be degraded.

### SUMMARY

Illustrative aspects of the present invention provide a smoothing circuit capable of suppressing a surge voltage from occurring in an inverter, and uniformly distributing current to a plurality of capacitors provided in a smoothing circuit of a voltage-type power supply, thereby preventing damage due to heat generated in the respective capacitors.

According to an illustrative aspect of the invention, a smoothing circuit includes a plate-shaped circuit body having a positive-side output terminal and a negative-side output terminal, and a plurality of capacitors mounted on the circuit body and connected to each other in parallel between the positive-side output terminal and the negative-side output terminal, each capacitor having a positive terminal and a negative terminal. The circuit body includes, for each capacitor, a positive electrical path connecting the positive terminal of the capacitor and the positive-side output terminal to each other and a negative electrical path connecting the negative terminal of the capacitor and the negative-side output terminal to each other. With a sum of a length of the positive electrical path and a length of the negative electrical path being defined as a positive-negative electrical path length for each capacitor, a difference between a maximum positive-negative electrical path length and a minimum positive-negative electrical path length among the positive-negative electrical path lengths is equal to or smaller than 30% of the minimum positive-negative electrical path length.

According to another illustrative aspect of the invention, a smoothing circuit includes a plate-shaped circuit body having a positive-side output terminal and a negative-side output terminal, and a plurality of capacitors mounted on the circuit body and connected to each other in parallel between the positive-side output terminal and the negative-side output terminal, each capacitor having a positive terminal and a negative terminal. The circuit body includes a positive solid pattern providing, for each capacitor, a positive electrical path connecting the positive terminal of the capacitor and the positive-side output terminal to each other, a negative solid pattern providing, for each capacitor, a negative electrical path connecting the negative terminal of the capacitor and the negative-side output terminal to each other, and an insulating layer interposed between the positive solid pattern and the negative solid pattern. With a middle point between the positive-side output terminal and the negative-side output terminal being defined as a base point and a distance from the base point to a middle point between the positive terminal and the negative terminal being defined as a distance to the capacitor for each capacitor, a difference between a maximum distance and a minimum distance among distances to the respective capacitors is equal to or smaller than 30% of the minimum distance.

According to another illustrative aspect of the invention, an inverter includes the smoothing circuit described above, and an inverter circuit connected to the positive-side output terminal and the negative-side output terminal of the smoothing circuit, and configured to convert DC power supplied from the smoothing circuit into AC power.

According to another illustrative aspect of the invention, a power supply apparatus includes the inverter described above, and a converter configured to convert AC power supplied from an AC power supply into DC power to supply the DC power to the smoothing circuit of the inverter.

Illustrative aspects of the present invention can provide a smoothing circuit capable of suppressing a surge voltage from occurring in an inverter, and can also provide an inverter and a power supply apparatus having improved protection for power semiconductor devices.

### BRIEF DESCRIPTION OF DRAWINGS

FIG. 1 is a block diagram illustrating an example of a power supply apparatus according to an embodiment of the present invention.

FIG. 2 is a schematic diagram illustrating a configuration example of a smoothing circuit of FIG. 1.

FIG. 3 is a cross-sectional view of the smoothing circuit, taken along the line III-III of FIG. 2.

FIG. 4 is a schematic diagram illustrating another configuration example of the smoothing circuit of FIG. 1.

FIG. 5 is a schematic diagram illustrating still another configuration example of the smoothing circuit of FIG. 1.

### DESCRIPTION OF EMBODIMENTS

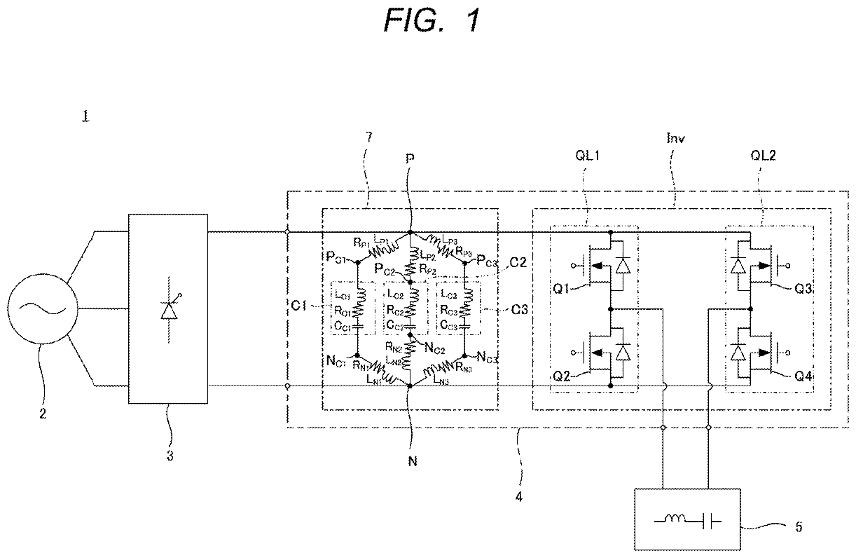

FIG. 1 illustrates an example of a power supply apparatus according to an embodiment of the present invention.

The power supply apparatus 1 includes a converter 3 configured to convert AC power supplied from an AC power supply 2 into DC power and an inverter 4 configured to convert the DC power output from the converter 3 into AC power.

The converter 3 may perform rectification using a diode bridge, for example, or perform rectification to vary an output voltage, using a semiconductor device such as a thyristor capable of controlling conduction based on an external signal.

As illustrated in FIG. 1, the inverter 4 has four power semiconductor devices Q1 to Q4 each configured to perform a switching operation. A first leg QL1 includes the power semiconductor device Q1 and the power semiconductor device Q2 connected to each other in series. The power semiconductor device Q1 is provided as an upper arm and the power semiconductor device Q2 is provided as a lower arm. A second leg QL2 includes the power semiconductor device Q3 and the power semiconductor device Q4 connected to each other in series. The power semiconductor device Q3 is provided as an upper arm and the power semiconductor device Q4 is provided as a lower arm. The first leg QL1 and the second leg QL2 together form an inverter circuit Inv.

The upper arm (the power semiconductor device Q1) of the first leg QL1 and the lower arm (the power semiconductor device Q4) of the second leg QL2 are turned on in synchronization with each other, and the lower arm (the power semiconductor device Q2) of the first leg QL1 and the upper arm (the power semiconductor Q3) of the second leg QL2 are turned on in synchronization with each other. Furthermore, the upper arm of the first leg QL1 and the lower arm of the second leg QL2 and the lower arm of the first leg QL1 and the upper arm of the second leg QL2 are alternately turned on in cycles. Accordingly, AC power is generated from DC power, and outputted from a serial contact point between the upper arm and the lower arm of each of the first leg QL1 and the second leg QL2.

A load 5 including a heating coil is connected to an AC output of the inverter 4, and the AC power generated by the inverter 4 is supplied to the heating coil. Furthermore, a heating target is induction-heated by the heating coil. The heating target and the heating purpose are not specifically limited, and a heat treatment (e.g., quenching) for a steel material can be exemplified.

The power semiconductor device may include various types of power semiconductor devices capable of performing a switching operation, such as an insulated gate bipolar transistor (IGBT) and metal-oxide-semiconductor field-effect transistor (MOSFET), and silicon (Si) or silicon carbide (SiC) may be used as the semiconductor material.

The inverter circuit Inv may constitute first to third legs using six power semiconductor devices, and generate three-phase AC power. The inverter 4 may include a plurality of inverter circuits Inv. When the inverter 4 includes the plurality of inverter circuits Inv. AC powers generated by the respective inverter circuits Inv are combined, and the combined AC power is supplied to the load 5 from the inverter 4.

The inverter 4 further includes a smoothing circuit 7. The smoothing circuit 7 smoothes DC power containing a ripple, which is output from the converter 3, and supplies the smoothed DC power to the inverter circuit Inv.

In the example of FIG. 1, one smoothing circuit 7 is provided for one inverter circuit Inv. However, when a plurality of inverter circuits Inv are provided, one smoothing circuit 7 may be provided for the plurality of inverter circuits Inv, or a plurality of smoothing circuits 7 may be used so that one smoothing circuit 7 is provided for one inverter circuit Inv.

In the example of FIG. 1, one smoothing circuit 7 is provided for the inverter circuit Inv including the first and second legs QL1. QL2. However, two smoothing circuits 7 may be used so that one smoothing circuit 7 is provided for each of the first and second legs QL1, QL2. When the inverter circuit Inv includes the first to third legs, three smoothing circuits 7 can be used and provided for the first to third legs, respectively.

The smoothing circuit 7 includes a plurality of capacitors connected in parallel to a DC output of the converter 3 and a DC input of the inverter circuit Inv. In the example of FIG. 1, the smoothing circuit 7 includes three capacitors C1, C2, C3. The capacitors C1, C2, C3 are mounted in a plate-shaped circuit body, and the circuit body includes a positive-side output terminal P connected to a positive side of the DC input of the inverter circuit Inv and a negative-side output terminal N connected to a negative side of the DC input of the inverter circuit inv. In the example of FIG. 1, the positive-side output terminal P and the negative-side output terminal N also serve as input terminals connected to the DC output of the converter 3, but the input terminals may be separately provided.

The capacitor C1 has a capacitance component C_{C1}, a resistance component R_{C1} and an inductance component L_{C1} therein. Furthermore, a resistance component RP1 and an inductance component L_{P1} are present in a positive electrical path between a positive terminal P_{C1} of the capacitor C1 and the positive-side output terminal P of the circuit body, and a resistance component R_{N1} and an inductance component L_{N1} are also present in a negative electrical path between a negative terminal N_{C1} of the capacitor C1 and the negative-side output terminal N of the circuit body.

Similarly, the capacitor C2 has a capacitance component C_{C2}, a resistance component R_{C2} and an inductance component L_{C2} therein, a resistance component R_{P2} and an inductance component L_{P2} are present in a positive electrical path between a positive terminal P_{C2} of the capacitor C2 and the positive-side output terminal P of the circuit body, and a resistance component R_{N2} and an inductance component L_{N2} are present in a negative electrical path between a negative terminal N_{C2} of the capacitor C2 and the negative-side output terminal N of the circuit body.

Furthermore, the capacitor C3 also has a capacitance component C_{C3}, a resistance component R_{C3} and an inductance component L_{C3} therein, a resistance component R_{P3} and an inductance component L_{P3} are present in a positive electrical path between a positive terminal P_{C3} of the capacitor C3 and the positive-side output terminal P of the circuit body, and a resistance component R_{N3} and an inductance component L_{N3} are present in a negative electrical path between a negative terminal N_{C3} of the capacitor C3 and the negative-side output terminal N of the circuit body.

Here, the current flowing through the capacitors C1, C2, C3 are related to the impedance between the positive-side output terminal P and the negative-side output terminal N, and high-frequency impedances Zi (i=1, 2, and 3) corresponding to the respective capacitors are expressed by the following equations.

Zi=√(Ri²+(ωLi)²)

Ri=R_{Ci}+R_{Pi}+R_{Ni}

Li=L_{Ci}+L_{Pi}+L_{Ni}

A variation in the high-frequency impedances Zi (i=1, 2, and 3) expressed by the above equation causes a variation in the currents flowing through the capacitors C1, C2, C3. The resistance component Ri typically has an extremely small value in the order of mΩ, and a dominant element deciding the high-frequency impedance Zi is considered as the inductance component Li. Therefore, when the inductance components Li are uniformized, it is possible to reduce a variation of the high-frequency impedances Zi, thereby preventing a variation in the currents flowing through the capacitors C1, C2, C3.

Furthermore, when the currents flowing through the capacitors C1, C2, C3 are uniformized, it is possible to reduce the entire equivalent inductance L of the smoothing circuit 7, obtained by combining the inductances Li containing the internal inductances LCi of the respective capacitors, thereby preventing a surge voltage L×di/dt generated across the power semiconductor devices Q1 to Q4.

The same capacitors are used as the capacitors C1, C2, C3, and the inductance components L_{Ci} (i=1, 2, and 3) of the capacitors C1, C2, C3 are equal to each other. Therefore, in order to uniformize the inductance components Li of the high-frequency impedances Zi, inductance L_{PNi} (L_{PNi}=L_{Pi}+L_{Ni}) corresponding to the sum of the inductance components L_{Pi} of the positive electrical paths and the inductance components L_{Ni} of the negative electrical paths in the capacitors C1, C2, C3 may be uniformized. Hereafter, the configuration of the smoothing circuit 7 for uniformizing the inductances L_{PNi} of the positive and negative electrical paths in the respective capacitors will be described.

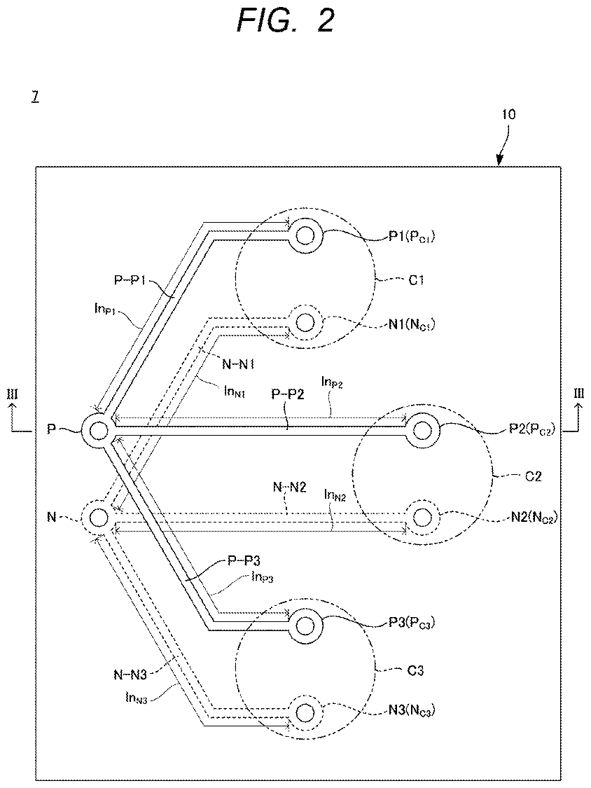

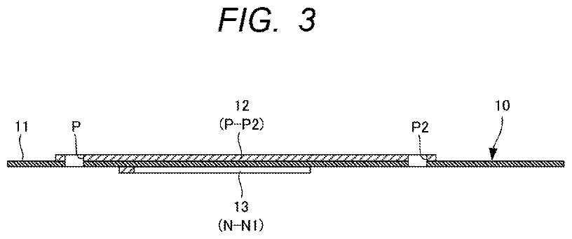

FIGS. 2 and 3 illustrate a configuration example of the smoothing circuit 7.

The circuit body 10 illustrated in FIGS. 2 and 3 is a so-called laminated bus bar in which metal plates 12, 13 such as copper plates are provided as layers on the front and back surfaces of an insulating sheet 11 in a laminated manner. The circuit body 10 is not limited to the laminated bus bar, and may include a bus bar, a power board substrate and the like.

The metal plate 12 provided as a layer on the front surface of the insulating sheet 11 includes a positive-side output terminal P and three strip-shaped conductors P-P1, P-P2, P-P3 extending in a branched manner from the positive-side output terminal P. The three conductors P-P1, P-P2, P-P3 have terminals P1, P2, P3 provided at respective ends thereof (ends at the opposite side of the positive-side output terminal P) and connected to the positive terminals PC1, PC2, PC3 of the capacitors C1, C2, C3, respectively. The conductors P-P1, P-P2, P-P3 form the positive electrical paths for the capacitors C1, C2, C3.

The metal plate 13 provided as a layer on the back surface of the insulating sheet 11 includes a negative-side output terminal N and three strip-shaped conductors N-N1, N-N2, N-N3 extending in a branched manner from the negative-side output terminal N. The three conductors N-N1, N-N2, N-N3 have terminals N1, N2, N3 provided at respective ends thereof (ends at the opposite side of the negative-side output terminal N) and connected to the negative terminals NC1 to NC3 of the capacitors C1, C2, C3, respectively. The conductors N-N1, N-N2, N-N3 form the negative electrical paths for the capacitors C1, C2, C3.

The strip-shaped conductors P-P1, P-P2, P-P3, N-N1, N-N2, N-N3 have substantially the same width.

In the example of FIGS. 2 and 3, the positive-side output terminal P has a hole passing through the circuit body 10, such that the positive-side terminal of the DC input of the inverter circuit Inv (see FIG. 1) or the bus bar connected to the positive-side terminal is screwed to the positive-side output terminal P, and the terminals P1, P2, P3 of the conductors P-P1, P-P2, P-P3 also have holes passing through the circuit body 10, such that the positive terminals PC1, PC2, PC3 of the capacitors C1, C2, C3 are screwed to the respective terminals P1, P2, P3. However, the positive-side output terminal P and the terminals P1, P2, P3 are not limited to screw terminals. Similarly, the negative-side output terminal N and the terminals N1, N2, N3 of the conductors N-N1, N-N2, N-N3 are not limited to screw terminals. Furthermore, although not illustrated, the metal plates 12, 13 are coated with an insulating layer while the terminals P, P1, P2, P3, N and N1, N2, N3 are exposed.

The length ln_{P1} of the strip-shaped conductor P-P1 is the length of the positive electrical path for the capacitor C1, the length ln_{N1} of the strip-shaped conductor N-N1 is the length of the negative electrical path for the capacitor C1, and the sum of the lengths ln_{P1}, and ln_{N1} is defined as a positive-negative electrical path length ln_{PN1} for the capacitor C1 (ln_{PN1}=ln_{Pi}+ln_{Ni}). Similarly, the length ln_{P2} of the strip-shaped conductor P-P2 is the length of the positive electrical path for the capacitor C2, the length ln_{N2} of the strip-shaped conductor N-N2 is the length of the negative electrical path for the capacitor C2, and the sum of the lengths ln_{P2} and ln_{N2} is defined as a positive-negative electrical path length ln_{PN2} for the capacitor C2 (ln_{PN2}=ln_{P3}+ln_{N2}). The length ln_{P3} of the strip-shaped conductor P-P3 is the length of the positive electrical path for the capacitor C3, the length ln_{N3} of the strip-shaped conductor N-N3 is the length of the negative electrical path for the capacitor C3, and the sum of the lengths ln_{P3} and ln_{N3} is defined as a positive-negative electrical path length ln_{PN3} for the capacitor C3 (ln_{PN3}=ln_{P3}+ln_{N3}).

Since the strip-shaped conductors P-P1, P-P2, P-P3, N-N1, N-N2, N-N3 have substantially the same width, the positive-negative electrical path lengths ln_{PN1}, ln_{PN2}, ln_{PN3} for the respective capacitors C1, C2, C3 correspond to the inductances L_{PN1} to L_{PN3} of the positive-negative electrical paths for the capacitors C1, C2, C3. Therefore, when the positive-negative electrical path lengths ln_{PN1}, ln_{PN2}, ln_{PN3} are uniformized, the inductances L_{PN1} to L_{PN3} of the positive-negative electrical paths for the capacitors C1, C2, C3 are uniformized. Moreover, when the inductances L_{PN1} to L_{PN3} of the positive-negative electrical paths for the capacitors C1, C2, C3 are uniformized, a variation in currents flowing through the capacitors C1, C2, C3 is prevented. As a result, a surge voltage is prevented since the inductances from the capacitors C1, C2, C3 to the power semiconductor devices Q1 to Q4 are extremely low.

In order to suppress a variation in the currents flowing through the capacitors C1, C2, C3, the difference Δln may be reduced, where Δln is the difference between the maximum positive-negative electrical path length lnₘₐₓ and the minimum positive-negative electrical path length lnₘᵢₙ (Δln=lnₘₐₓ−lnₘᵢₙ) among the positive-negative electrical path lengths ln_{PN1}, ln_{PN2}, ln_{PN3} for the capacitors C1, C2, C3. It is preferable that the difference Δln be as small as possible. Considering that the difference Δln is equal to or greater than 50% of lnₘᵢₙ in related art smoothing circuits including a plurality of capacitors, the difference Δln may be designed to be, for example, equal to or smaller than 30% of lnₘᵢₙ (Δln≤0.3×lnₘᵢₙ).

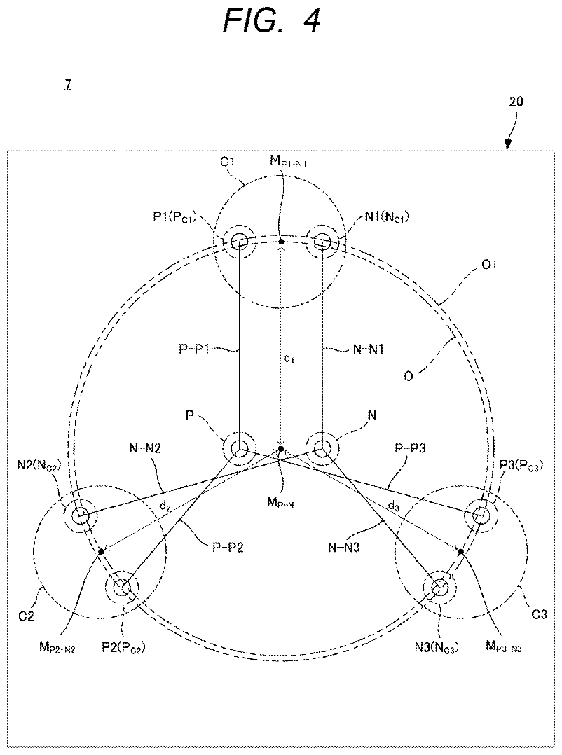

FIG. 4 illustrates another example of a configuration of the smoothing circuit 7.

In the example illustrated in FIG. 4, a circuit body 20 is configured as a laminated bus bar like the circuit body 10 described above. However, a metal plate provided as a layer on the front surface of the insulating sheet and forming the positive electrical paths for the capacitors C1, C2, C3 is configured as a solid pattern covering the entire front surface of the insulating sheet, and a metal plate provided as a layer on the back surface of the insulating sheet and forming the negative electrical paths for the capacitors C1, C2, C3 is configured as a solid pattern covering the entire back surface of the insulating sheet.

The metal plate layer on the front surface of the insulating sheet includes a positive-side output terminal P and terminals P1, P2, P3 to which the positive terminals PC1, PC2, PC3 of the capacitors C1, C2, C3 are connected. The positive-side output terminal P is provided approximately at the center of the circuit body 20, and the terminals P1, P2, P3 are arranged around the positive-side output terminal P. Since current flows along the shortest path of a homogeneous conductor, a straight line P-P1 connecting the positive-side output terminal P and the terminal P1 becomes the positive electrical path for the capacitor C1. Similarly, a straight line P-P2 connecting the positive-side output terminal P and the terminal P2 becomes the positive electrical path for the capacitor C2, and a straight line P-P3 connecting the positive-side output terminal P and the terminal P3 becomes the positive electrical path for the capacitor C3.

The metal plate layer on the back surface of the insulating sheet includes a negative-side output terminal N and terminals N1, N2, N3 to which the negative terminals N_{C1} to N_{C3} of the capacitors C1, C2, C3 are connected. The negative-side output terminal N is provided approximately at the center of the circuit body 20 and provided adjacent to the positive-side output terminal. The terminals N1. N2, N3 are arranged around the negative-side output terminal N. The terminal N1 is provided adjacent to the terminal P1, the terminal N2 is provided adjacent to the terminal P2, and the terminal N3 is provided adjacent to the terminal P3. Like the positive electrical path, a straight line N-N1 connecting the negative-side output terminal N and the terminal N1 becomes the negative electrical path for the capacitor C1, a straight line N-N2 connecting the negative-side output terminal N and the terminal N2 becomes the negative electrical path for the capacitor C2, and a straight line N-N3 connecting the negative-side output terminal N and the terminal N3 becomes the negative electrical path for the capacitor C3.

The length lnP1 of the straight line P-P1 is the length of the positive electrical path for the capacitor C1, the length ln_{N1} of the straight line N-N1 is the length of the negative electrical path for the capacitor C1, and the sum of the lengths ln_{P1} and ln_{N1} is defined as a positive-negative electrical path length ln_{PN1} for the capacitor C1 (ln_{PN1}=ln_{P1}+ln_{N1}). Similarly, the length ln_{P2} of the straight line P-P2 is the length of the positive electrical path for the capacitor C2, the length ln_{N2} of the straight line N-N2 is the length of the negative electrical path for the capacitor C2, and the sum of the lengths lnP2 and ln_{N2} is defined as a positive-negative electrical path length ln_{PN2} for the capacitor C2 (ln_{PN2}=ln_{P2}+ln_{N2}). The length lnP3 of the straight line P-P3 is the length of the positive electrical path for the capacitor C3, the length ln_{N3} of the straight line N-N3 is the length of the negative electrical path length for the capacitor C3, and the sum of the lengths ln_{P3} and ln_{N3} is defined as a positive-negative electrical path length ln_{PN3} for the capacitor C3 (ln_{PN3}=ln_{P3}+ln_{N3}).

The positive-negative electrical path lengths ln_{PN1}, ln_{PN2}, ln_{PN3} for the respective capacitors C1, C2, C3 correspond to the inductances L_{PN1} to L_{PN3} of the positive-negative electrical paths for the capacitors C1, C2, C3, as in the above-described circuit body 10. Therefore, it is possible to suppress a variation in currents flowing through the capacitors C1, C2, C3 by designing the difference Δln to be equal to or smaller than 30% of lnₘᵢₙ, where Δln is the difference between the maximum positive-negative electrical path length lnₘₐₓ and the minimum positive-negative electrical path length lnₘᵢₙ (Δln=lnₘₐₓ−lnₘᵢₙ) among the positive-negative electrical path lengths ln_{PN1}, ln_{PN2}, ln_{PN3} for the respective capacitors C1, C2, C3.

The positive-negative electrical path lengths ln_{PN1}, ln_{PN2}, ln_{PN3} for the capacitors C1, C2, C3 can be replaced with distances from the positive-side output terminal P and the negative-side output terminal N to the capacitors C1, C2, C3.

Here, the middle point M_{P1-N1} between the terminal P1 (the positive terminal P_{C1}) and the terminal N1 (the negative terminal N_{C1}) is defined as the position of the capacitor C1. Similarly, the middle point M_{P2-N2} between the terminal P2 (the positive terminal P_{C2}) and the terminal N2 (the negative terminal N_{C2}) is defined as the position of the capacitor C2, and the middle point M_{P3-N3} between the terminal P3 (the positive terminal P_{C3}) and the terminal N3 (the negative terminal N_{C3}) is defined as the position of the capacitor C3. With the middle point M_{P-N} between the positive-side output terminal P and the negative-side output terminal N being the base point, a distance to the middle point M_{P1-N1} is defined as a distance d1 to the capacitor C1, a distance to the middle point M_{P2-N2} is defined as a distance d2 of the capacitor C2, and a distance to the middle point M_{P3-N3} is defined as a distance d3 of the capacitor C3. It is possible to suppress a variation in the currents flowing through the capacitors C1, C2, C3 by designing the difference Δd to be equal to or smaller than 30% of dₘᵢₙ, where Δd is the difference between the maximum distance dₘₐₓ and the minimum distance dₘᵢₙ (Δd=dₘₐₓ−dₘᵢₙ) among the distances d1 to d3 to the capacitors C1, C2, C3.

In order to suppress a variation in the currents flowing through the capacitors C1, C2, C3, it is preferable that the difference Δd be as small as possible. Thus, in the example of FIG. 4, the terminals P1, P2, P3 and the terminals N1. N2, N3 are arranged on a circle O1 centered on the middle point M_{P-N} between the positive-side output terminal P and the negative-side output terminal N. According to this arrangement of the terminals P1, P2, P3 and the terminals N1. N2, N3, the middle points M_{P1-N1}, M_{P2-N2}, M_{P3-N3} of the capacitors C1, C2, C3, defining the distances d1 to d3, are also arranged on another circle O centered on the middle point M_{P-N}. Accordingly, the distances d1 to d3 of the capacitors C1, C2, C3 become equal to each other, and Δd becomes nearly zero. In other words, the inductance components L_{P1}, L_{P2}, L_{P3} of the positive electrical paths and the inductance components L_{N1}, L_{N2}, L_{N3} of the negative electrical paths in the capacitors C1, C2, C3 become nearly equal to each other

(L_{P1}≈L_{P2}≈L_{P3}≈L_{N1}≈L_{N2}≈L_{N3}),

and the inductances L_{PN1} to L_{PN3} corresponding to the sums of the inductance components of the positive electrical paths and the inductance components of the negative electrical paths also become nearly equal to each other

(L_{PN1}≈L_{PN2}≈L_{PN3}).

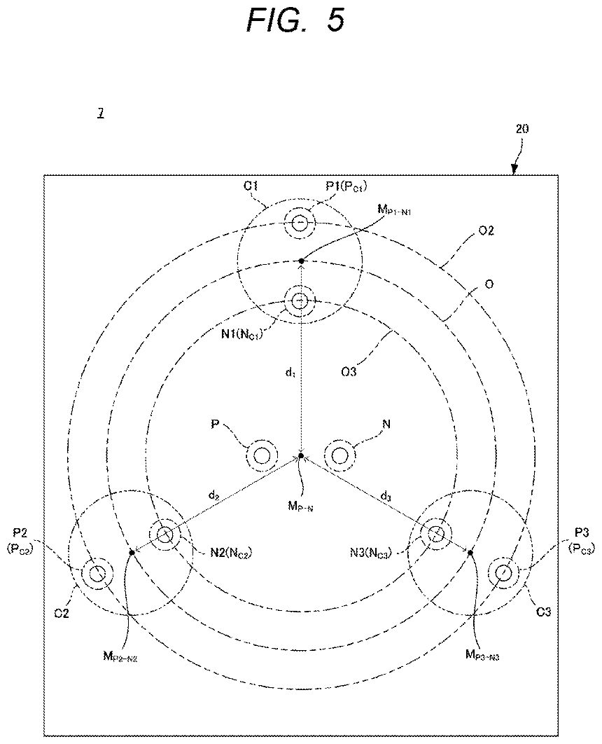

In the example of FIG. 5, the terminals P1, P2, P3 are arranged on a first circle O2 centered on the middle point M_{P-N} between the positive-side output terminal P and the negative-side output terminal N, and the terminals N1, N2, N3 are arranged on a second circle O3 centered on the middle point _{MP-N} and which is different from the first circle O2. According to this arrangement of the terminals P1, P2, P3 and the terminals N1, N2, N3, the middle points M_{P1-N1}, M_{P2-N2}, and MP3-N3 of the capacitors C1, C2, C3, defining the distances d1 to d3, are arranged on one circle O centered on the middle point M_{P-N}. Accordingly, the distances d1 to d3 of the capacitors C1, C2, C3 become nearly equal to each other, and Δd becomes nearly zero. In this case, the inductance components L_{P1}, L_{P2}, L_{P3} of the positive electrical paths in the capacitors C1, C2, C3 become nearly equal to each other

(L_{P1}≈L_{P2}≈L_{P3}),

the inductance components L_{N1}, L_{N2}, L_{N3} of the negative electrical paths in the capacitors C1, C2, C3 are nearly equal to each other

(L_{N1}≈L_{N2}≈L_{N3}),

and the inductances L_{PN1} to L_{PN3} corresponding to the sums of the inductance components of the positive electrical paths and the inductance components of the negative electrical paths also become nearly zero

(L_{PN1}≈L_{PN2}≈L_{PN3}).

So far, it is been described that three capacitors C1, C2, C3 are mounted on the circuit body of the smoothing circuit 7. However, the number of capacitors is not limited thereto, as long as a plurality of capacitors are provided. For example, the number of capacitors may be two, four or more.

As described above, according to an illustrative aspect of the present invention, a smoothing circuit includes a plate-shaped circuit body having a positive-side output terminal and a negative-side output terminal, and a plurality of capacitors mounted on the circuit body and connected to each other in parallel between the positive-side output terminal and the negative-side output terminal, each capacitor having a positive terminal and a negative terminal. The circuit body includes, for each capacitor, a positive electrical path connecting the positive terminal of the capacitor and the positive-side output terminal to each other and a negative electrical path connecting the negative terminal of the capacitor and the negative-side output terminal to each other. With the sum of the length of the positive electrical path and the length of the negative electrical path being defined as the positive-negative electrical path length for each capacitor, the difference between the maximum positive-negative electrical path length and the minimum positive-negative electrical path length among the positive-negative electrical path lengths is equal to or smaller than 30% of the minimum positive-negative electrical path length.

According to another illustrative aspect of the present invention, the circuit body may include a positive solid pattern providing the positive electrical paths for the respective capacitors, a negative solid pattern providing the negative electrical paths for the respective capacitors, and

an insulating layer interposed between the positive solid pattern and the negative solid pattern, and with the middle point between the positive-side output terminal and the negative-side output terminal being defined as a base point and the distance from the base point to the middle point between the positive terminal and the negative terminal being defined as a distance to the capacitor for each capacitor, the difference between the maximum distance and the minimum distance among the distances to the respective capacitors is equal to or smaller than 30% of the minimum distance.

The middle point between the positive terminal and the negative terminal of each capacitor may be arranged on a circle centered on the base point.

The positive terminal and the negative terminal of each capacitor may be arranged on another circle centered on the base point.

The positive terminals of the plurality of capacitors may be arranged on a first circle centered on the base point, and the negative terminals of the plurality of capacitors may be arranged on a second circle centered on the base point, the second circle being different from the first circle.

An inverter may include the smoothing circuit and an inverter circuit connected to the positive-side output terminal and the negative-side output terminal of the smoothing circuit. The inverter is configured to convert DC power supplied from the smoothing circuit to AC power.

A power supply apparatus may include the inverter and a converter configured to convert DC power supplied from the AC power supply into DC power and to supply the converted DC power to the smoothing circuit of the inverter.

This application claims priority to Japanese Patent Application No. 2017-212184 filed on Nov. 1, 2017, the entire content of which is incorporated herein by reference.

1. A smoothing circuit comprising:
a plate-shaped circuit body having a positive-side output terminal and a negative-side output terminal; and
a plurality of capacitors mounted on the circuit body and connected to each other in parallel between the positive-side output terminal and the negative-side output terminal, each capacitor having a positive terminal and a negative terminal,
wherein the circuit body comprises, for each capacitor, a positive electrical path connecting the positive terminal of the capacitor and the positive-side output terminal to each other and a negative electrical path connecting the negative terminal of the capacitor and the negative-side output terminal to each other, and
wherein, where a sum of a length of the positive electrical path and a length of the negative electrical path is defined as a positive-negative electrical path length for each capacitor, a difference between a maximum positive-negative electrical path length and a minimum positive-negative electrical path length among the positive-negative electrical path lengths is equal to or smaller than 30% of the minimum positive-negative electrical path length.

2. The smoothing circuit according to claim 1, wherein the circuit body comprises:
a positive solid pattern providing the positive electrical paths for the respective capacitors;
a negative solid pattern providing the negative electrical paths for the respective capacitors; and
an insulating layer interposed between the positive solid pattern and the negative solid pattern,
wherein, where a middle point between the positive-side output terminal and the negative-side output terminal is defined as a base point and a distance from the base point to a middle point between the positive terminal and the negative terminal is defined as a distance to the capacitor for each capacitor, a difference between a maximum distance and a minimum distance among the distances to the respective capacitors is equal to or smaller than 30% of the minimum distance.

3. The smoothing circuit according to claim 2, wherein the middle point between the positive terminal and the negative terminal of each capacitor is arranged on a circle centered on the base point.

4. The smoothing circuit according to claim 3, wherein the positive terminal and the negative terminal of each capacitor are arranged on another circle centered on the base point.

5. The smoothing circuit according to claim 3, wherein the positive terminals of the plurality of capacitors are arranged on a first circle centered on the base point, and
wherein the negative terminals of the plurality of capacitors are arranged on a second circle centered on the base point, the second circle being different from the first circle.

6. An inverter comprising:
the smoothing circuit according to claim 1; and
an inverter circuit connected to the positive-side output terminal and the negative-side output terminal of the smoothing circuit, and configured to convert DC power supplied from the smoothing circuit into AC power.

7. A power supply apparatus comprising:
the inverter according to claim 6; and
a converter configured to convert AC power supplied from an AC power supply into DC power and to supply the DC power to the smoothing circuit of the inverter.

8. The smoothing circuit according to claim 1, wherein the positive electrical path and the negative electrical path are both straight.

9. An inverter comprising:
the smoothing circuit according to claim 2; and
an inverter circuit connected to the positive-side output terminal and the negative-side output terminal of the smoothing circuit, and configured to convert DC power supplied from the smoothing circuit into AC power.

10. An inverter comprising:
the smoothing circuit according to claim 3; and
an inverter circuit connected to the positive-side output terminal and the negative-side output terminal of the smoothing circuit, and configured to convert DC power supplied from the smoothing circuit into AC power.

11. An inverter comprising:
the smoothing circuit according to claim 4; and
an inverter circuit connected to the positive-side output terminal and the negative-side output terminal of the smoothing circuit, and configured to convert DC power supplied from the smoothing circuit into AC power.

12. An inverter comprising:
the smoothing circuit according to claim 5; and
an inverter circuit connected to the positive-side output terminal and the negative-side output terminal of the smoothing circuit, and configured to convert DC power supplied from the smoothing circuit into AC power.
